(19) United States
(12) Patent Application Publication
(10) Pub. No.: US 2003/0136261 A1
(43) Pub. Date: Jul. 24, 2003

(54) Gas storage capsule and method for filling said capsule

(76) Inventor: Anatoly Yakovlevich Stolyarevsky, Moscow (RU)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/064,924

(22) Filed: Aug. 29, 2002

Related U.S. Application Data
(63) Continuation of application No. PCT/RU01/00083, filed on Feb. 26, 2001.

(30) Foreign Application Priority Data
Feb. 29, 2000 (RU) RU2000014684

(51) Int. Cl. B01D 53/02

(52) U.S. Cl. 95/90; 96/108

(57) ABSTRACT

The capsule and method for its filling concern to engineering of storage of gases and may be used in medicine, in household chemistry, in fire engineering, in perfumery, as a source of gas for inflatables etc. The invention will allow to simplify and speed up processes of creation of superfluous pressure in aerosol and others inflatable products to raise safety of their operation. The capsule for storage of gas contains the gastight case inside which particles of a sorbent for sorpting gas are placed, is supplied with the release tightened channel. According to the invention the case contains a free cavity from a sorbent which volume is sufficient for accommodation of the given quantity of sorpting gas in a firm phase, and is executed with an opportunity of introduction inside of the case sorpting gas in a firm phase. The method for filling of a capsule by gas includes a premise of a sorbent in a capsule containing the gastight case, having ability of a keeping of particles of a sorbent and an opportunity to let out gas from a capsule, sorption by a sorbent of gas. According to the invention inside a capsule form a free cavity from a sorbent in which enter the given quantity of gas in a firm phase.

### BACKGROUND OF INVENTION

This application claims priority from an international application PCT/RU01/00083 filed on Feb. 26, 2001 and having a priority date of Feb. 29, 2000, which application is incorporated herein by reference.

The invention relates to packaging and may be used, for example, in aerosol packings used for drawing paint and varnish covering, in the perfume industry, in fire technology, and also for the distribution of products of household chemistry and carbonation of drinks.

The known spraying container contains the case, the distributing valve—which is established in an aperture on a wall of the case—an aerosol liquid, propellant, the sorbent sated by the propellant, all of which are placed inside the case.(International application PCT/RU92/00129, with date between the international submission from Jun. 26, 1992, with date of a priority from Jun. 29, 1991, and the number of international publication WO 93/00277 from Jul. 1, 1993, lntCl. B 65 D 83/14).

Filling this spraying container is done through the refueling valve for a sorbent and propellant, and the valve for sprayed substance, which provides a high level of filling of the case with spraying liquid. At the same time, the known design calls for the creation of special equipment for filling a spraying container. In other words, it is necessary to create automated rotary lines for refilling these designs since existing rotary lines are not capable of carrying out refills of such spraying containers, and reuse of these spraying containers for various sprayed substances and gas is not possible, since there is a complexity of clearing of the case of spraying container and preparation of a sorbent.

Also known is a spraying container comprising the following: a case, propellant and capsule disposed inside the case, sorbent particles saturated with the propellant gas and disposed inside the capsule, and a filtering element serving as a covering case of the capsule and permeable to the gas propellant and impermeable to the sorbent particles. (Patent of U.S. Pat. No. 3,964,649, with date of the publication 22.06. 76, U.S.Cl. 222/399).

The described device is relatively simple, because filling such a device with a spraying liquid and a capsule can be carried out through an opening in the wall of the case before the installation of the distributing valve.

Also known is a method of filling a spraying case by placing a sorbent in a capsule impermeable to the sorbent particles and permeable to the gas propellant. Furthermore, the method involves filling the sorbent with the gas propellant, inserting the spraying liquid, propellant and the capsule inside the case of the spraying container and hermetizing the case of the spraying container. (Patent of U.S. Pat. No. 3,964,649, with date of the publication 22.06.76, U.S.CI. 222/399).

In this way quality of saturation of a sorbent may be worsened by gas—propellant in view of an opportunity of penetration into a sorbent of the substances having greater, than propellant, heat of sorption in a sorbent.

The gas storage capsule, containing the gastight case inside which the particles of a sorbent sated with gas are placed, supplied for the release tightened channel (patent RU 2086489, lntCI. 65 D 83/14, 10. 08.1 997) is known also. The known device is supplied locking an exit of gas with the means lowering a degree of saturation of a sorbent by gas and focused on a given technical opportunity of its opening that narrows potential variants of use of a capsule.

### SUMMARY OF INVENTION

Technical result which may be received at realization of the invention, maintenance of a high degree of saturation of a sorbent with gas and expansion of opportunities of application of a capsule.

For achievement of the specified technical result in a known gas storage capsule, containing the gastight case inside which particles of a sorbent for sorption of the gas are placed, supplied with the release tightened channel according to the invention the case contains a free cavity from a sorbent which volume is sufficient for accommodation of the given quantity of sorpting gas in a firm phase, and is executed with an opportunity of introduction inside of the case sorpting gas in a firm phase.

Tightening of the release channel may be executed as the valve supplied with an elastic element, opening release of gas from a capsule only at excess of pressure inside a capsule of pressure of outside a capsule on the given value.

The case may be executed as the cylinder connected from two or more parts.

The valve may be placed on a joint of parts of the case.

As elastic element of the valve the part of the case executed as a petal may serve.

The release tightened channel may be executed as the molecular sieve passing only molecules of sorpting gas.

For the solution of a task in view with achievement of technical result in a known method of filling of a capsule with a sorbent gas by a premise of a sorbent in a capsule containing the gastight case, having ability of a keeping of particles of a sorbent and an opportunity to let out gas from a capsule, sorption of gas by a sorbent according to the invention inside a capsule form a free cavity in which enter the given quantity of sorpting gas in a firm phase.

The variant of realization of a method in which gas enter in a capsule before filling a capsule by a sorbent is possible.

The variant of realization of a method in which a capsule form as the cylinder executed from two or more parts is possible.

Due to application of the specified methods of filling, and also performance of a capsule from a gastight material, supply by its release tightened channel, introductions of a free cavity from a sorbent which volume is sufficient for accommodation of the given quantity of sorpting gas in a firm phase, and performance of the case with an opportunity of introduction inside of the case sorpting gas in a firm phase it was possible to solve a task in view with achievement of technical result.

### BRIEF DESCRIPTION OF DRAWINGS

Advantages, and also features of the present invention become clear during the subsequent consideration of the best variants of realization of the invention given below with references to applied drawings.

FIG. 1 diagrammatically illustrates a section of a capsule.

FIG. 2 is a place of a joint of parts of the case of the capsule shown on FIG. 1, at performance of an elastic element as an elastic ring.

FIG. 3 is the same, that FIG. 2, at performance of an elastic element as a petal to which the part of the case serves.

FIG. 4 shows a part of the case of a capsule with an elastic element as a percussion cap established in a window of the case.

FIG. 5 is a part of the case of a capsule with the acting release channel tightened with a molecular sieve and an rupture membrane.

### DETAILED DESCRIPTION

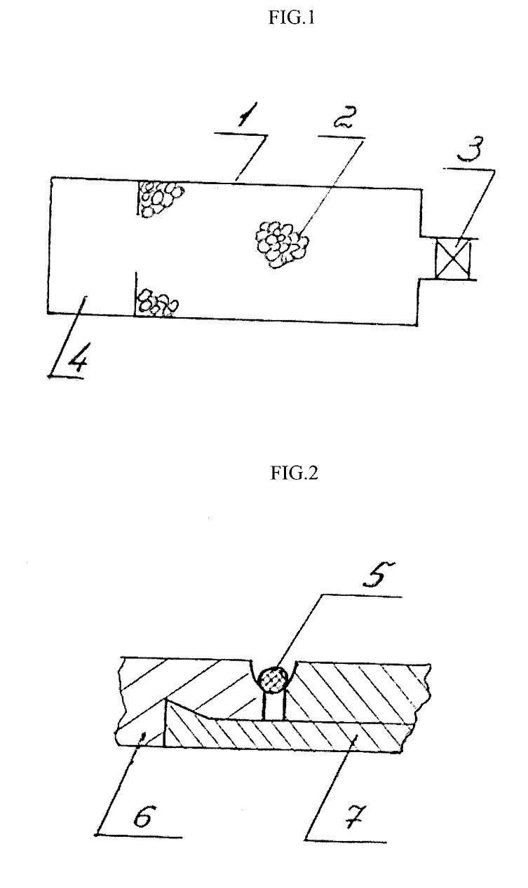

Capsule (FIG. 1) contains the case 1, particles of a sorbent 2 for sorpting of gas (gas on FIG. 1 is not shown), the release tightened channel 3 and a free cavity from a sorbent 4, placing in itself the given quantity of sorpting gas in a firm and—or liquid phase.

Tightening of the release channel 3 may be executed as the valve supplied with an elastic element, opening release of gas from a capsule 1 only at excess of pressure inside a capsule of pressure outside a capsule on the given value.

The elastic element 5 may be executed as an elastic ring as it is shown on FIG. 2 which is established on an exhaust outlet of the release tightened channel formed in the given variant of performance by a joint between parts of the case 6 and 7, and opens an exit of gas from a capsule only if pressure difference between internal and external surfaces of this ring exceeds the working pressure difference causing an output of gas through an exhaust outlet of the channel 3. In the given variant of performance of a capsule elasticity of the elastic ring 5 which are carried out, for example, from rubber, is defined by the required settlement deformation creating pressure of compression, the exceeding pressure of a stretching caused by working pressure difference.

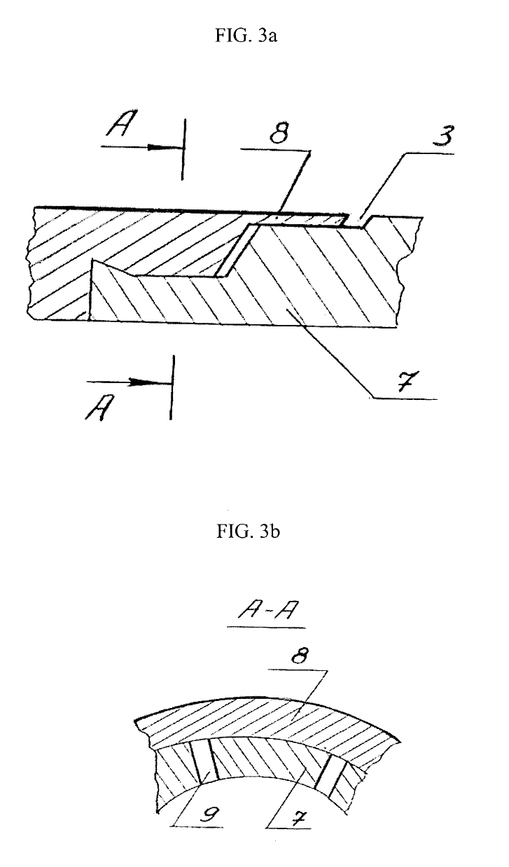

The elastic element 5 may be executed as a petal 8 formed by one of parts of the case as it is shown on FIG. 3, as the most simple for installation of the form not demanding mutual positioning of a surface of installation and providing dense tight sealing of surfaces of parts of the case 6 and 7. For installation of one part of the case on another in one of them—a part 7 which are taking place inside in sealing unit, may be executed chinks 9 in the holding ledge, facilitating moving of parts during installation 6.

At the same time variants of performance of an element 5 as a membrane, an elastic percussion cap, cramp, a wedge and other known constructive elements providing given rate of compression of an elastic element 5 and opportunity of release of gas are possible.

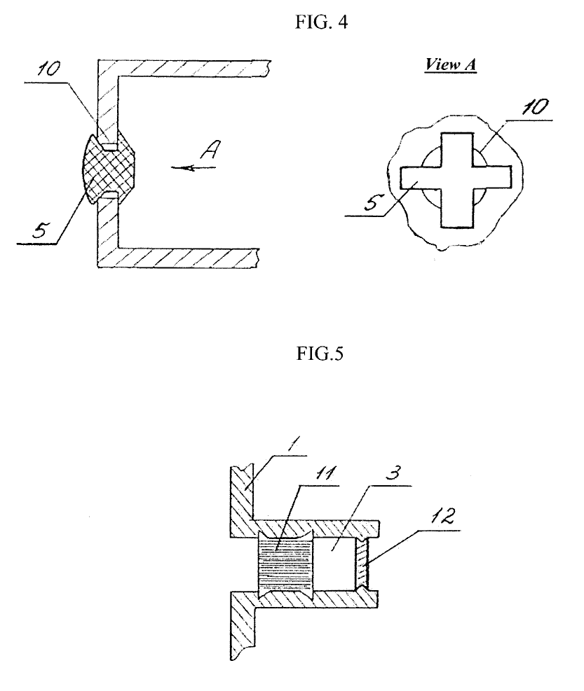

In particular, the elastic element 5 may be executed as a percussion cap made, for example, from rubber and installed in a window 10 of case 1 as may be seen in FIG. 4. In this variant of an elastic element 5 it may serve as a valve closing an aperture of a window 10 after filling of a capsule by particles of a sorbent 2 and sorpting gas in a firm phase.

Tightening of the release tightened channel 3 may be executed as a molecular sieve as it is shown on FIGS. 1 and 5 which is established in an exhaust outlet of the release tightened channel 3 formed in the given variant of performance durable case 1. Such element serves for pass through the release channel only molecules of sorpting gas and interferes with penetration inside of the case 1 of molecules of greater diameter, for example organic chemistry, characteristic for structures which circle covers practically all possible applications of the capsules which are carried out according to the invention.

For prevention of premature loss of gas from a capsule before pressure in it will be risen up to the given amount (at transition of gas from a solid or liquid phase in gas with simultaneous gas absorption in a sorbent 2) the release channel may be supplied with an rupture membrane 12.

Prevention of an exit of gas in a mode of phase changes of sorpting gas is reached also by presence of tightening of the release channel 3 executed, for example, as shown in FIG. 2, as an elastic ring 5 or a valve—percussion cap in the refueling window 10, installed after refilling gas and a sorbent as additional means of prevention of receipt inside of the case 1, under action of higher, than inside a capsule of pressure, the components of an environment causing replacement of gas from a sorbent or influencing required quality of environment as, for example, in case of use of a capsule as of a source of gas—propellant in perfumery aerosol packings.

It is expedient to provide the means preventing hit of particles of a sorbent in the channel 3 for pass of gas which may be the porous elements executed as a part of the case 1, for example, as lattice on an inlet aperture of the channel 3 or as the inserts of a molecular sieve 11 separating a cavity of accommodation of particles of a sorbent from a final aperture of the channel 3 placed as separate filtering gas-permeable elements.

The elastic element 5 may be executed as the elastic stocking covering the case 1 so, that at absence of a difference of pressure inside and outside of the case 1 exit of gas from a capsule is blocked.

The capsule as follows works.

In a mode of refilling and short-term storage, for example, on a line of use of capsules or a warehouse internal excess pressure inside a capsule does not reach a preset value until then while a solid phase sorpting gas, evaporating under action of an environment, will not saturate up to the given level a sorbent that promoted by the lowered temperature of adsorption, provided with taking of heat on phase transition of gas.

Thus overlapping a final aperture by an elastic element 5 as it is kept from moving by compressing force is provided.

Thus hermetic sealing of the release tightened channel is provided.

At a premise of a capsule in a working environment, for example, inside of the container in which excessive pressure should be created, phase transition of gas results in growth of pressure inside a capsule and the elastic element 5 executed, for example, as an elastic petal of tightening 8 (FIG. 3) it is unclenched and under action of internal pressure in a capsule it is wrung out from a landing surface, informing thus a cavity of a sorbent 2 with environment environmental a capsule through the release channel 3. Gas leaves thus a capsule until pressure outside of a capsule not risen up to the amount distinguished from value of pressure in a cavity of a sorbent 5 on preset value, then due to own elasticity an elastic element of tightening 5 (FIGS. 1, 2 and 4), 8 (FIG. 3) will return to a starting position, and will block pass of gas from a cavity of a sorbent 2 through an exhaust outlet of the channel 3.

At pressure decrease in a working environment the process described above repeats.

Irrespective of the chosen real designs for the decision of a task in view with achievement of technical result it is necessary and to realize the way of refilling described above for what refilling of a capsule conduct by a premise of a sorbent in a capsule having ability of a keeping of particles of a sorbent and an opportunity to let out gas from a capsule enough, and sorption by a sorbent of gas according to the invention inside a capsule form a free cavity in which enter the given quantity of gas in a firm phase.

For prevention of an exit of gas from a capsule in a mode of its refilling and improvement of conditions of saturation of a sorbent gas enter in a capsule before filling a capsule by a sorbent.

With the purpose of simplification and acceleration of operation of refilling of a capsule a capsule form as the cylinder executed from two or more parts.

Such process of refilling is expedient for carrying out in a conveyor mode directly ahead of a premise of a capsule in the device maintaining it, for example, aerosol packing with the purpose of maximal use of the gas placed in a capsule.

As have shown experiments characteristic times of process of phase transition CO2 make (at a premise of the last in the plastic cylinder in the condensed solid condition) tens seconds, that more than on the order exceeds characteristic speeds of work of industrial aerosol lines.

Let's consider value of this factor at use of a capsule as source of gas in the aerosol spraying container for creation of the necessary pressure of gas above 0.3 MPa for full dispersion of a liquid in volume 250 ml provided that the free volume of gas outside of a liquid and capsules is chosen in spraying container minimal (for example, less than 25 ml). In this example the required quantity of gas, desorpted from a capsule inside of spraying container, should be not less than 750 ml or about, 1.5 g at use as gas CO2. At use as a sprayed liquid of water or structures on its basis for creation of necessary pressure inside packing also it is necessary to take into account absorption of gas by water which for initial pressure 0.75 MPa will demand desorption from a capsule in addition 0.4 g some gas and also to take into account filling by gas of the free volume demanding 0.4 g more. In view of the residual contents of gas in a sorbent at final pressure 0.3 MPa at a level 0.5 g, the total of gas filled in a capsule with a stock on losses at refilling will make about 3 g.

Thus if as a sorbent use the activated carbon such as SKT, and initial pressure in the case 1 of capsule create equal 0.75 MPa at temperature 22C the required quantity of a sorbent should be about 5 g, that will demand at density of filling by a sorbent of a capsule 0.4 g/ml volume not less than 12 ml.

The volume of the cavity necessary for accommodation of firm phase CO2 given quantities 2.5 g, will make (at condensation of a solid phase up to 1 g/ml) about 2.5 ml.

At evaporation of specified quantity CO2 inside a capsule placed inside of aerosol packing, gas will be in part sorpt in a sorbent up to the equilibrium condition determined by pressure inside a capsule and equilibrium temperature that will make under the mentioned above conditions about 1.8 g sorpted gas. Other part evaporated solid phase CO2 will be absorbed by a liquid, will fill in free volume of aerosol packing and will be lost during refilling.

As gas it is the most expedient to use CO2, Ar, N₂, O₂, N₂O, and as a sorbent the activated carbon, zeolite, silicagel or their mixes. Selection of various types of sorbents (for example, the activated carbon+zeolite) allows to optimize operating conditions of refilling, storage and use of a capsule.

As example of realization of the way of refilling described in the declared invention the following set of operations with reference to the device described above on an example may serve.

The sorbent prepared to refilling, i.e. disgassed, for example, by preliminary pumping out at heating, place in the case 1 of capsule then in a capsule, using, for example, a window 10 in the case 1, enter in the condensed firm phase CO2 (so-called—“dry ice”), formed as a tablet, pellet or a ball then in a window 10 establish tightly adjoining to an exhaust outlet the elastic element 5 executed in the given variant as a rubber percussion cap. The collected thus and filled capsule desert after that in the packing preliminary filled with a liquid sprayed. The following operation on packing establish and roll of spraying valve.

Taking into account high industrial speed of last operations (less than 1 second), losses of the gas leaving a capsule outside of packing, are reduced thus to small quantities.

The invention may be used in medicine, in fire engineering for creation of pressure in extinguisher devices, in household chemistry, in perfumery, as a source of gas for inflatables and beer kegging equipment etc.

1. Gas storage capsule, containing the gastight case inside which particles of a sorbent for sorption of the gas are placed, supplied with the release tightened channel, characterized by further providing inside the case a free cavity from a sorbent which volume is sufficient for accommodation of the given quantity of sorpting gas in a firm phase, and it is executed with an opportunity of introduction inside of the case sorpting gas in a firm phase.

2. Capsule according to claim 1, wherein tightening of the release channel is executed as the valve supplied with an elastic element, opening release of gas from a capsule only at excess of pressure inside a capsule of pressure of environment environmental a capsule on the given value.

3. Capsule according to claim 1 or 2, wherein the case is executed as the cylinder connected from two or more parts.

4. Capsule according to claim 3, wherein the valve is placed on a joint of parts of the case.

5. Capsule according to any claim from 2 to 4, wherein as an elastic element of the valve the part of the case executed as a petal serves.

6. Capsule according to claim 1, wherein the release tightened channel is executed as the molecular sieve passing only molecules of sorpting gas.

7. Capsule according to any claim from 1 to 7, wherein the release tightened channel is supplied with an rupture membrane.

8. Method for filling of a capsule with a sorbent gas by a premise of a sorbent in a capsule containing the gastight case, having ability of a keeping of particles of a sorbent and an opportunity to let out gas from a capsule, sorption by a sorbent of the gas, characterized by further providing inside the gastight case form a free cavity in which enter the given quantity of sorpting gas in a firm phase.

9. Method according to claim 8, wherein enter gas in a capsule before filling a capsule by a sorbent.

10. Method according to claim 8 or 9, wherein form a capsule as the cylinder executed from two or more parts.
